(19) United States
(12) Patent Application Publication
(10) Pub. No.: US 2009/0296365 A1
(43) Pub. Date: Dec. 3, 2009

(54) CALIBRATED AND COLOR-CONTROLLED MULTI-SOURCE LIGHTING SYSTEM FOR SPECIMEN ILLUMINATION

(75) Inventor: Richard M. Haddock, Redwood City, CA (US)

Correspondence Address: SCHNECK & SCHNECK, P.O. BOX 2-E, SAN JOSE, CA, 95109-0005, US

(73) Assignee: CoinSecure, Inc., Palo Alto, CA (US)

(21) Appl. No.: 12/426,875

(22) Filed: Apr. 20, 2009

Related U.S. Application Data
(60) Provisional application No. 61/046,344, filed on Apr. 18, 2008.

(51) Int. Cl. G03B 15/02; G07D 5/00

(52) U.S. Cl. 362/4; 194/328

(57) ABSTRACT

A coin illumination source comprises a geometric feature configured to surround a coin under evaluation, a plurality of illumination sources mounted within the geometric feature, and a viewing aperture through which an imaging device can capture an image of the coin.

### CROSS-REFERENCE TO RELATED APPLICATION

The present invention claims priority from provisional application Ser. No. 61/046,344, filed Apr. 18, 2008.

### TECHNICAL FIELD

The present invention relates generally to coin collecting and valuation of coins, and more particularly, to a color-controlled source used to quantitatively evaluate the coins.

### BACKGROUND

The interest in the collection and conservation of coins and related objects has been historically considered a personal interest activity, with little formal standards or controls concerning the trading of coins. The recent rise in the value of coins compared to earlier levels has promoted the trading of coins to a higher degree of professional structure, most significantly by the advent of commercial third party coin grading services who have developed systems to apply a widely accepted quality grade (based on a numerical scale from 1 to 70 with 70 being the highest quality). After examining and determining the grade of a coin, the commercial services place the coin in a clear plastic holder in which a grade label with a reference barcode is affixed. The clear plastic holder is then ultrasonically welded around the coin, thus permanently linking the grade to the coin within the case. A barcode is linked to the database which can be searched to confirm that the referenced coin was graded by the commercial service, along with some additional transaction details such as the date, place, person grading the coin, etc.

The grading service charges a fee for the provided services and gives a warranty of grading accuracy as part of the transaction value. The result of this commercial service is to allow the plastic encapsulated coins to be more readily traded as their trade value is directly linked to the professional quality grade on the plastic holder.

However, the current commercial grading services can lack repeatability and consistency. Further, current services are unable to prevent “grader shopping” in which a coin owner may specifically hunt for the highest value for a given coin by removing the coin from the plastic holder and re-submitting it since there is currently not a mean to identify a specific coin outside of the labeled box or other rigorous objective means for identifying a specific coin.

Moreover, coin grades are frequently influenced by color or tonality of the coin surfaces. These parameters can have a significant effect on a valuation level of a coin. However, imaging a coin using an improper or non-repeatable light source can either intentionally or unintentionally significantly alter the color or tonality of the coin when creating a reference coin image. Therefore, an improved illumination source is needed for coin imaging systems.

In addition to coin grading, with the increasing use of on-line cataloging, internet sales and auctions, and other electronic media to exchange coins, the use of digital images for the cataloging and valuing of coins is becoming increasingly important. However there are a number of challenges for the illumination of coins. The coins are made of differing material which cause a variation in reflectivity and scattering. An improved illumination source is needed for the proper imaging of coins.

### SUMMARY

In various exemplary embodiments, a coin illumination source is disclosed. In one embodiment the coin illumination source comprises a geometric feature configured to surround a coin under evaluation, a plurality of illumination sources mounted on an outer portion of the geometric feature, and a viewing aperture located on the feature and configured to capture an image of the coin.

### BRIEF DESCRIPTION OF THE DRAWINGS

The appended drawing illustrates an exemplary embodiment of the present invention and must not be considered as limiting its scope.

FIG. 1 is an exemplary hemispherical apparatus to illuminate a coin.

FIG. 2 is an exemplary apparatus for two level illumination of a coin.

FIG. 3 is a flow chart for illumination of a coin.

### DETAILED DESCRIPTION

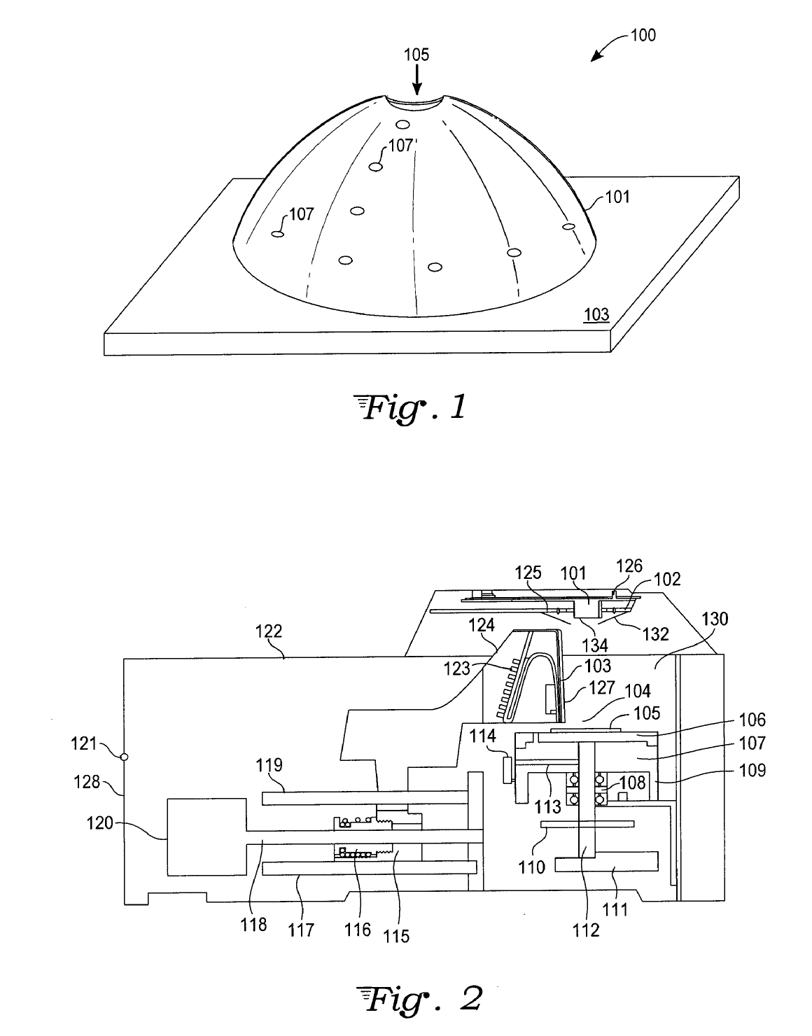

With reference to FIG. 1, an exemplary hemispherical coin illumination apparatus 100 includes a translucent hemisphere 101 mounted on a plate 103. The translucent hemisphere 101 may be placed over a sample coin placed on the plate 103. The translucent hemisphere 101 further includes a viewing aperture 105 and a plurality of illumination sources 107 mounted in various angular and azimuthal positions on an outer portion of the translucent hemisphere 101. In a specific exemplary embodiment, red, green, and blue (RGB) light emitting diodes (LEDs), placed in close proximity to one another, are arranged in six groups on the translucent hemisphere 101.

The viewing aperture 105 may be used to house, for example, a digital lens imaging system once a required color-temperature or range of temperatures is established within the translucent hemisphere 101. The viewing aperture 105 may also be used to determine or set a specified illumination level or color-temperature prior to imaging the coin set on the plate 103 inside the translucent hemisphere 101. Intensity level measurements of light are well-known in the art. Other illumination and color balancing techniques are described, below.

In an exemplary embodiment, each of the plurality of illumination sources 107 may individually be controlled for an overall intensity level. Further, shadowing effects may be achieved by varying an intensity level from one side of the translucent hemisphere 101 to another. Depending upon the source chosen, the plurality of illumination sources 107 may individually be controlled for color-temperature or wavelength as well. In all cases however, all variations can be measured and recorded to provide repeatable and consistent configurations.

Color-control may be obtained in a variety of ways. For example, a color meter (e.g., a Konica-Minolta CR-400 Chroma Colorimeter manufactured by Konica-Minolta Sensing Americas, Inc., 101 Williams Drive Ramsey, N.J. 07446 USA) may be used to record and achieve a specific color balance. Frequently, a 5500° K (Kelvin) to 7000° K color-temperature measurement emulates typical daylight illumination. In some cases, a ultraviolet or near-infrared (near-IR) wavelength may be needed. Overall, there are several ways to vary color-balance.

Using a tri-color light source enables the user to change the color balance. For example, three light emitting diodes containing the three primary colors of red, green, and blue (RGB) may be coupled at each location of the plurality of illumination sources 107 to obtain a tri-color light source. A drive current to each color of LED will control the intensity of a given LED and hence, the overall color balance. Thus, the drive current to one or two of the colors may be controlled to achieve a particular color-temperature as noted by the color meter.

Optionally, an output of a color sensor placed within the viewing aperture 105 may be changed to achieve a preferred color temperature. For example, individual RGB outputs from a color CMOS sensor or CCD array can be tuned individually to achieve the preferred color-temperature regardless of the light source being used. (The light source needs, of course, at least some level of continuous color spectrum in the visible range. A single-temperature source (e.g., a sodium vapor lamp) can not be adjusted to other than its narrow-band color output level.)

In yet another option, a combination of light sources and color sensor output levels may both be adjusted. Further, since a variety of ways exist to establish a given color-temperature or wavelength, the translucent hemisphere 101 need not be completely uniform in either optical density or color.

In another exemplary embodiment in which color balance is unnecessary, the plurality of illumination sources 107 may be comprised of sources with a known or well-defined output.

For example, photographic flash heads are generally specified as having a known color-temperature, typically 5500° K to 6500° K. In this case, a user of the hemispherical coin illumination apparatus 100 may only be concerned with relative or absolute intensity levels between the plurality of illumination sources 107. Optionally, additional diffusers (not shown) can be utilized with any of the illumination arrangements described.

In another example, the color-temperature may be chosen to have a narrow-band output to view features of a coin other than tonality such as defects that are noticeable only when irradiated by particular wavelengths. For instance, a near-infrared (near-IR) laser (e.g., lasing at 810 nm) may be useful under such conditions. The colorimeter may still be inserted through the viewing aperture to determine the illumination bandwidth.

In yet another example, a broadband source may be used directly or with filtering mechanisms to achieve a given color-temperature. The filtering mechanism may be an optical subtractive filter or a more complex mechanism, such as a monochromator, known in the art. The broadband source may be coupled to the outer portion of the translucent hemisphere by, for example, fiber optic strands or bundles.

In another exemplary embodiment (not shown directly but readily envisioned by reference to FIG. 1 and what is known to a skilled artisan upon reading the following description), the translucent hemisphere 101 is replaced by a Coblentz sphere. A Coblentz sphere is known in the art and consists of a sphere that is covered on an inside periphery by a mirror (typically, a front-surface mirror). In this embodiment, the plurality of illumination sources is mounted on the inside of the Coblentz sphere. The plurality of illumination sources may also be individually controlled for intensity as noted above. Additionally, in the case of a multi-color illumination source, the plurality of illumination sources may additionally be individually controlled for color balance. The intensity and color-temperature balancing detailed above may be readily applied to a Coblentz sphere implementation as well.

Another embodiment is illustrated in FIG. 2. In this embodiment other an illumination system and a coin is shown. In FIG. 2 a turntable 507 holds an adapter 506 which centers the coin in a field of view. The coin may be illumination by an upper bank of LEDs 525, 526 at LED illumination board 502 and the lower bank of LEDs 504. This lower bank is in two parts, one on the optical head light housing 524 and one on a wall encircling the coin. In this embodiment, the geometric feature containing the lights is not a dome but levels of lights, the lower level in a band of LEDs and the upper bank in a ring of LEDs surrounding the camera. The optical head light housing would be positioned during imaging such that individual LEDs in the lower LED bank had substantially equal distance from the center of the coin, when the coin is centered on the platform. The camera 501 takes a picture through an aperture in light diffuser 532.

The LED bank may include a number of different colored lights or lights of all one color, such as white LEDS, and some variation in angle of the lights. For example, LEDs 525, 526 may include white, yellow, blue, red, multicolor or other color selection. A user or automatic control could allow for optimal illumination of the coin. Some coins which are highly reflective may not photograph well using illumination from above. For example, newly minted silver coins have a highly reflective surface, making imaging of the surface features of the coin difficult. The lower bank of lights would allow for less direct light, which could be angled onto the coin, or scattered onto the coin.

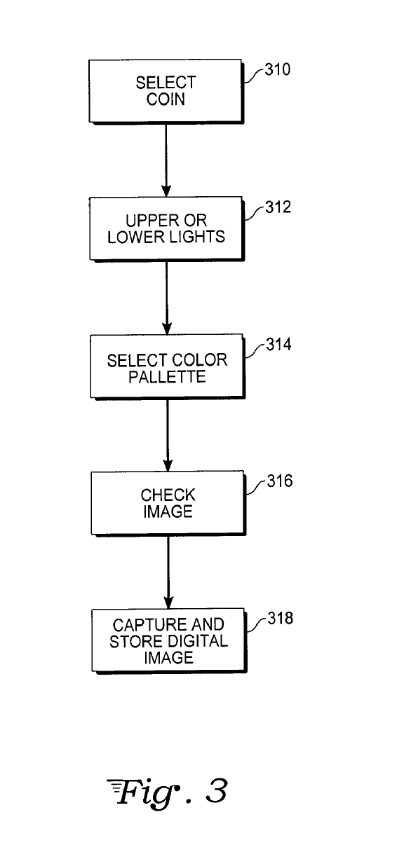

In taking an image of the coin an automated process allows selection of the suitable illumination. This is shown with respect to FIG. 3. Initially, a coin type is selected for image capture (block 310). This could include selection from a drop down menu, input of the coin type into a control computer, or other selection means. Selection of this coin would provide the system with information about the coin, including material of the coin (e.g. gold, silver, etc), mint date (which would have an impact on coin luster) and other coin properties. From a database the system would select a combination of upper and/or lower rings of light for illumination of the target (block 312). The system would also use the selected coin to determine a color palate (block 314) to best capture the image of the coin. The image would then be checked (block 314), either manually or via the automated system. The system would then capture and store the digital image of the coin (block 318).

The present invention is described above with reference to specific embodiments thereof. It will, however, be evident to a skilled artisan that various modifications and changes can be made thereto without departing from the broader spirit and scope of the present invention as set forth in the appended claims. For example, particular embodiments describe techniques for measuring color-temperature with a removable colorimeter. A skilled artisan will recognize that other colorimeter types exist and may be permanently affixed to measure within the translucent hemisphere. Further, each system, once initially constructed and calibrated, may include a small reference sample, such as an 18% gray-scale reflector, to readily recalibrate the system. In certain situations, calibrating either sensors or tri-color LED arrangements to have a similar electrical output may also provide consistent color-temperatures. Also, the translucent hemisphere can take other forms as well such as a cylinder, enclosed rectangle, or other substantially-closed geometric feature. Moreover, although shown as substantially orthogonal to the plate, the viewing aperture may be located at various positions on the hemisphere to best facilitate photographing or otherwise taking measurements from a coin. These and various other embodiments are all within a scope of the present invention. The specification and drawings are, accordingly, to be regarded in an illustrative rather than a restrictive sense.

What is claimed is:

1. A coin illumination source and imaging device, comprising:
a geometric feature configured to surround a coin under evaluation;
a plurality of illumination sources mounted at different levels of the geometric feature;
a control allowing selection of a pattern of illumination sources based on a target coin; and
a camera configured to capture an image of the coin under evaluation.

2. The device of claim 1, wherein said geometric feature include a dome.

3. The device of claim 1, wherein said geometric feature includes an upper bank of illumination sources and a lower bank of illumination sources.

4. The device of claim 1, wherein said illumination sources include different color illumination sources.

5. The device of claim 1, wherein said control is an automated control.

6. The device of claim 5, wherein said control includes a calorimeter.

7. The device of claim 1, wherein said control includes a user input.

8. The device of claim 3, wherein at least one bank of illumination sources includes some illumination sources mounted on a movable element of the device.

9. A method of coin imaging, comprising:
imputing into a system control a coin type;
based on coin composition and coin reflectivity, activating illumination sources on at least one level from which a coin will be illuminated;
based on coin composition and coin reflectivity, activating illumination sources of a color palette for illumination of the coin; and
capturing an image of the coin.

10. The method of coin imaging of claim 9, further comprising passing light from said illumination sources through a light diffuser.

11. The method of claim 10, wherein capturing an image of the coin includes focusing a camera through an aperture in the light diffuser.
